(19) United States
(12) Patent Application Publication
(10) Pub. No.: US 2016/0108966 A1
(43) Pub. Date: Apr. 21, 2016

(54) ROLLING-ELEMENT BEARING

(71) Applicants: AKTIEBOLAGET SKF, Göteborg (SE); SKF ECONMOS DEUTSCHLAND GMBH, Bietigheim-Bissingen (DE)

(72) Inventors: Matthias Krebs, Neckargemünd-Dilsberg (DE); Mathias Seuberling, Großeibstadt (DE)

(73) Assignees: SKF Economos Deutschland GmbH, Bietigheim-Bissingen (DE); Aktiebolaget SKF, Göteborg (SE)

(21) Appl. No.: 14/889,636

(22) PCT Filed: Apr. 24, 2014
(86) PCT No.: PCT/EP2014/058339

§ 371 Date: Nov. 6, 2015

(30) Foreign Application Priority Data
May 6, 2013 (DE) 10 2013 208 203.7

(51) Int. Cl. F16C 33/80; F16C 19/38; F16C 33/78

(52) U.S. Cl. CPC F16C 33/805; F16C 33/7813; F16C 19/386; F16C 33/7886; F16C 33/7889

(57) ABSTRACT

A rolling-element bearing having a diameter greater than 50 cm includes an inner ring, an outer ring, a plurality of rolling elements between the inner ring and the outer ring, and a seal ring. The seal ring is disposed on a surface of the inner ring or on a surface of the outer ring, and the outer ring or the inner ring includes a recess having at least one interior surface, and the seal ring extends into the recess. Either the seal ring does not contact the at least one interior wall of the recess or the seal ring includes a seal body and a seal lip and the seal body does not contact the at least one interior wall of the recess.

Exemplary embodiments relate to rolling-element bearings and in particular to rolling-element bearings having a diameter greater than 50 cm.

In rolling-element bearings it is of decisive importance for the service life to protect the interior of the rolling-element bearing, wherein the rolling elements are disposed, from external influences, such as dust and water. Conversely lubricant should also be prevented from escaping from the rolling-element bearing.

For this purpose various sealing systems are known, which differ depending on the type of rolling-element bearing and the requirements posed.

For example, radial shaft seals are used in large bearings, such as double row tapered roller bearings (DRTRB, double row tapered roller bearing). However, these have high wear and must be replaced frequently, whereby a high maintenance cost for such rolling-element bearings arises.

There is therefore a need to provide a rolling-element bearing that makes it possible to reduce the maintenance cost.

This object is achieved by a rolling-element bearing according to claim 1.

A rolling-element bearing according to an exemplary embodiment having a diameter of more than 50 cm comprises an inner ring, an outer ring, a plurality of rolling elements lying between the inner ring and the outer ring, and at least one seal ring. The seal ring is disposed on a surface of the inner ring or of the outer ring and correspondingly the outer ring or the inner ring includes a recess. The recess is configured and disposed to surround a predominant part of the exposed surface of the seal ring in a contact-free manner so that a labyrinth seal is formed, by the seal ring and the recess, between an interior of the rolling-element bearing for receiving the rolling elements and an exterior of the rolling-element bearing.

In large bearings, such as rolling-element bearings having a diameter of more than 50 cm, a contact free seal can be achieved by the integration of a labyrinth seal. The maintenance cost for the rolling-element bearing can thereby be significantly reduced. In this respect the costs for the maintenance, but also material costs for new seal rings, can be reduced due to less wear.

A rolling-element bearing according to another exemplary embodiment comprises an inner ring, an outer ring, a plurality of rolling elements lying between the inner ring and the outer ring, and at least one seal ring. The seal ring is disposed on a surface of the inner ring or of the outer ring, and correspondingly the outer ring or the inner ring includes a recess. The recess is configured and disposed to surround a predominant part of the exposed surface of the seal ring in a contact-free manner so that a labyrinth seal is formed, by the seal ring and the recess, between an interior of the rolling-element bearing for receiving the rolling elements and an exterior of the rolling-element bearing. Here the seal ring is comprised at least partially of a rubber elastomer or a thermoplastic polymer, such as, e.g., polyurethane.

By using a seal ring that is comprised at least partially of a rubber elastomer or a thermoplastic polymer, a labyrinth seal can be formed that is in principle a non-contact seal, with which, however, significant damage cannot even occur if in operation the seal ring contacts the surface of the recess from time to time. In contrast to the use of steel rings as the seal ring for labyrinth seals, the minimum space between a surface of the recess and the seal ring can be reduced by the described concept, so that the seal effect of the labyrinth seal is increased, and/or the use of a labyrinth seal in rolling-element bearings having large diameters (greater than 50 cm) is made possible, since in such large diameters steel rings are difficult to integrate in the rolling-element bearing, and the movement tolerances in large bearings are higher. By using a labyrinth seal as a non-contact seal the maintenance cost can generally be reduced. In addition, with the use of a seal ring according to the described concept a contact of the seal ring with the surface of the recess can cause far less damage than a contact of a seal ring made from steel, so that at this location the maintenance cost can also be reduced.

In some exemplary embodiments the seal ring is disposed on a surface of the inner ring, and the outer ring includes the recess. Here the outer ring comprises a recess-forming component and a cover, which together form the recess. The cover is connected to the recess-forming component by again-releasable connecting means. The seal is thereby easily accessible and can be replaced by removal of the cover. The time outlay for an exchange of the seal ring can thereby be significantly reduced.

In a rolling-element bearing according to an exemplary embodiment, wherein the seal ring is disposed on a surface of the inner ring and the outer ring includes the recess, the inner ring can include a groove, and the outer ring a bulge protruding into the groove. The seal ring can thereby be held in its position on the surface of the inner ring, whereby the probability of a contacting of the surface of the recess by the seal ring can be reduced.

In some exemplary embodiments the seal ring includes a seal lip that leads from the rest of the seal ring to a surface of the recess and is in contact with the surface of the recess. Due to the integration of a seal lip into the labyrinth seal, the advantages of a non-contact labyrinth seal can be combined with the improved sealing properties of a contact seal. The preload of the seal lips on the surface of the recess can be selected so low that the friction losses are negligible and the wear is kept within limits. However, it can be ensured that it is nearly impossible for dust or water to reach the interior of the rolling-element bearing from outside.

A rolling-element bearing of an exemplary embodiment can be, e.g., a cylindrical roller bearing or a tapered roller bearing, in particular a double row or four-row tapered roller bearing. These rolling-element bearing types are usually used for large bearings (diameter greater than 50 cm). According to the described concept, a labyrinth seal can be used in such large bearings so that the maintenance cost can be significantly reduced.

Preferred exemplary embodiments of the present invention are explained in greater detail below with reference to the accompanying FIGURE.

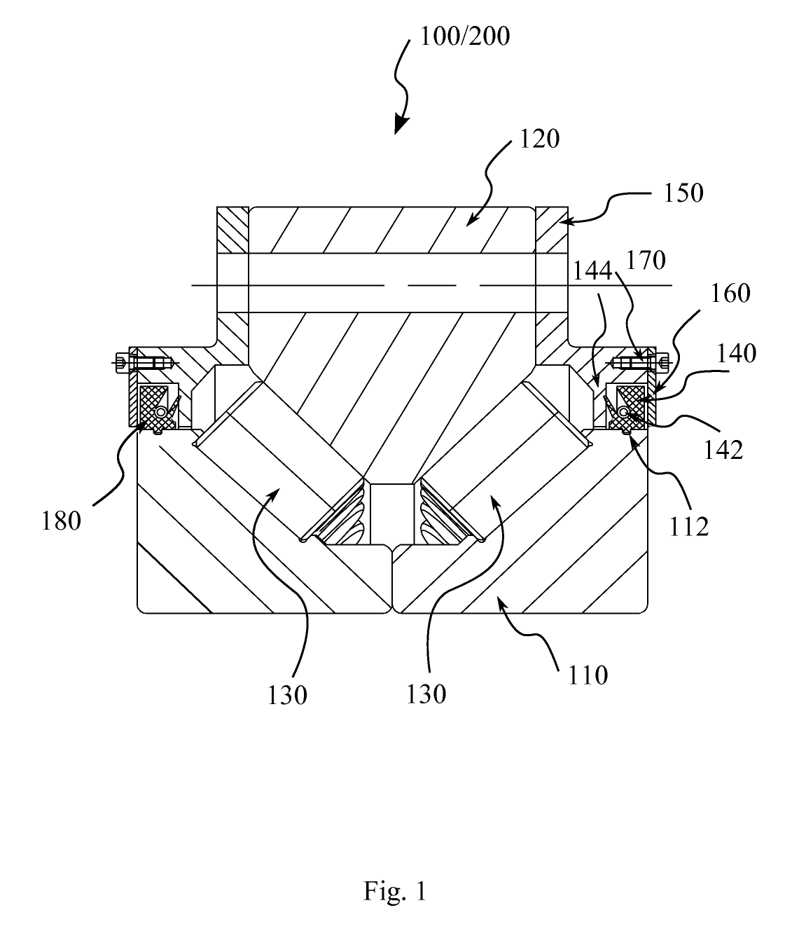

FIG. 1 shows a sectional view through a part of a rolling-element bearing.

In the following, the same reference numbers can sometimes be used with various described exemplary embodiments for objects and functional units which have the same or similar functional properties. Furthermore, optional features of the different exemplary embodiments can be combinable or interchangeable with one another.

FIG. 1 shows a sectional view of a rolling-element bearing 100 as an exemplary embodiment. The rolling-element bearing 100 having a diameter greater than 50 cm comprises an inner ring 110 (IR, inner ring), an outer ring 120 (OR, outer ring), a plurality of rolling elements 130 lying between the inner ring 110 and the outer ring 120, and at least one seal ring 140. The seal ring 140 is disposed on a surface of the inner ring 110 or of the outer ring 120, and correspondingly the outer ring 120 or the inner ring 110 includes a recess. The recess is configured and disposed to surround a predominant part of the exposed surface of the seal ring 140 in a contact-free manner so that a labyrinth seal is formed, by the seal ring 140 and the recess, between an interior of the rolling-element bearing 100 for receiving the rolling elements 130 and an exterior of the rolling-element bearing 100.

By using a labyrinth seal the maintenance cost of the rolling-element bearing can be significantly reduced since the wear is significantly less than with contact seals. In other words, in large bearings, such as rolling-element bearings having a diameter of more than 50 cm, a non-contact seal can be achieved by the integration of a labyrinth seal. The maintenance cost for the rolling-element bearing can thereby be significantly reduced. In this respect the costs for the maintenance, but also material costs for new seal rings, can be reduced due to less wear.

The rolling elements 130 are disposed in the interior of the rolling-element bearing 100. This region of the rolling-element bearing should be protected by the labyrinth seal against penetrating dust or water. Conversely, possibly present lubricant should be prevented from escaping from the rolling-element bearing. The exterior of the rolling-element bearing 100 is that region that no longer belongs to the rolling-element bearing 100, and via which dust or water can penetrate into the rolling-element bearing through the surrounding environment.

The seal ring 140 is disposed on a surface of the inner ring 110 or of the outer ring 120. In this respect the seal ring 140 includes a non-exposed surface (a surface in contact with the inner ring or the outer ring). The remaining part of the surface of the seal ring 140 can be referred to as the exposed surface. This exposed surface of the seal ring 140 is for the most part surrounded by the recess in a contact-free manner. That means that over a predominant part of the exposed surface of the seal ring 140 a surface of the recess is closer to the exposed surface of the seal ring 140 than the interior or the exterior of the rolling-element bearing 100. By a “predominant part” of the free surface at least 50% (or 70, 80, or 90%) of the exposed surface of the seal ring 140 is meant.

The seal ring 140 can be disposed on a cylindrical surface of the inner ring 110 or of the outer ring 120 (which, e.g., is rotationally symmetric to a rotational axis of the rolling-element bearing), wherein the cylindrical surface is disposed between the interior and the exterior of the rolling-element bearing 100. Accordingly in this example the seal ring 140 would be circular in its longitudinal extension (and in its cross-section, for example, substantially rectangular or square).

The seal ring 140 can extend over the entire circumference of the inner ring 110 (circular, annular), and correspondingly the recess can extend over the entire inner circumference of the outer ring 120 (circular, annular).

The seal ring 140 (or labyrinth seal) can be comprised, for example, of a metal, such as, e.g., steel. However, the seal ring 140 is preferably comprised at least partially (or completely) of a rubber elastomer (e.g. nitrile rubber) or a thermoplastic elastomer (e.g., polyurethane).

By using a seal ring that is comprised at least partially of a rubber elastomer or a thermoplastic polymer, a labyrinth seal can be formed that is in principle a non-contact seal, with which, however, significant damage cannot even occur if in operation the seal ring contacts the surface of the recess from time to time. In contrast to the use of steel rings as the seal ring for labyrinth seals, the minimum space between a surface of the recess and the seal ring can be reduced by the described concept, so that the seal effect of the labyrinth seal is increased, and/or the use of a labyrinth seal in rolling-element bearings having large diameters (greater than 50 cm) is made possible, since in such large diameters steel rings are difficult to integrate in the rolling-element bearing, and the movement tolerances in large bearings are higher.

The recess can surround the seal ring 140, for example, in a U-shaped manner. If the seal ring 140 is, e.g., substantially rectangular or square, then the U-shaped recess surrounds the predominant part of the three exposed sides of the seal ring. With the fourth side the seal ring 140 is then disposed on the inner ring 110 or the outer ring 120.

In addition to the already-explained elements for a specific exemplary embodiment, the rolling-element bearing 100 from FIG. 1 shows additional optional and mutually combinable details, such as, e.g., a groove 112, a recess-forming component 150 (seal carrier), a cover 160, a garter spring 142, a seal lip 144, a releasable connecting means 170, or a second seal ring 180. These optional elements are discussed below. One or more of these optional elements can be combined with the generally described concept.

The seal ring 140 can be disposed on a surface of the outer ring, and the inner ring 110 can include the recess. However, preferably the seal ring 140 is disposed on a surface of the inner ring 110, and the outer ring 120 includes the recess, since in this example the seal ring 140 can simply be held in its position on the surface of the inner ring. For example, the seal ring 140 can comprise a seal body and a spring, such as, e.g., a garter spring 142. The seal body and the garter spring 142 can be disposed such that the seal body is pressed against the inner ring 110 by the garter spring 142. The seal ring 140 can thereby be held simply in its position on the surface of the inner ring.

Optionally the inner ring 110 (or alternatively the outer ring (120) can include a groove 112, and the seal ring 140 a bulge protruding into the groove 112, so that the seal ring 140 is held in its position on the surface of the inner ring 110 (or alternatively of the outer ring 120). Conversely, the seal ring 140 could also include a groove, and the inner ring 110 a bulge protruding into the groove. Above all with respect to forces that act on the seal ring 140 parallel to the surface of the inner ring 110, the groove 112 can prevent a slipping of the seal ring 140.

In combination a garter spring can also be used in addition to the groove 112 in order to press the seal ring 140 against the inner ring 110 in order to prevent a slipping-out of the seal ring 14 out of the groove 112 due to forces acting orthogonally to the surface of the inner ring 110 (e.g., centrifugal forces due to the rotation of the rolling-element bearing).

Furthermore, the outer ring 120 (or the inner ring 110) can optionally comprise a recess-forming component 150 and a cover 160, which together form the recess. Here the cover 160 can be connected to the recess-forming component 150 by again-releasable connecting means (e.g., screws). It can thereby be made possible to exchange the seal ring 140 with little effort by removal of the cover 160. The maintenance cost can thereby be further significantly reduced.

In one possible design the recess-forming component 150 lies opposite the seal ring 140 on two sides in an L-shape, and the cover 160 lies opposite the seal ring 140 on a third side, so that the recess-forming component 150 and the cover 160 surround the seal ring 140 in a U-shaped manner. The open side of the U-shaped recess then, for example, lies opposite the surface of the inner ring 110 on which the seal ring 140 is disposed.

In a U-shaped design of the recess the gap of the labyrinth seal extends in a U-shaped manner around the seal ring 140. For example, only a gap between the surface of the inner ring 110 and a first side of the U-shaped recess towards the interior of the rolling-element bearing 100, and a second gap between the surface of the inner ring 110 and a second side of the recess towards the exterior of the rolling-element bearing 100 are present, which are connected to each other via the U-shaped gap of the labyrinth seal. In other words, the recess can be configured such that the exposed surface of the seal ring 140 is completely surrounded by the recess up to a gap towards the interior of the rolling-element bearing 100 for receiving the rolling elements 130 and a gap towards the exterior of the rolling-element bearing 100. Here a maximum distance of a point of the exposed surface of the seal ring 140 to a nearest point on a surface of the recess can be smaller than 2 cm (or smaller than 1 cm, 0.8 cm, or 0.5). The smaller the maximum distance is chosen, the better the seal effect of the labyrinth seal. Conversely, however, the probability increases that in operation a contact of the seal ring 140 and a surface of the recess results.

Optionally the seal ring 140 includes a seal lip that leads from the rest of the seal ring 140 to a surface of the recess and is in contact with the surface of the recess.

The seal lip 144 can, for example, enclose an acute angle with the surface of the recess, so that a contact surface of the seal lip 144 with the surface of the recess is farther removed along the labyrinth of the formed labyrinth seal from the interior of the rolling-element bearing 100 for receiving the rolling elements 130 than a terminal region of the seal lip 144 on the rest of the seal ring 140. In other words, the seal lip 144 can be designed such that it approaches the surface of the recess obliquely from the rest of the seal ring 140 and contacts, so that lubricant can escape from the interior of the rolling-element bearing 100 before dust or water can penetrate from the exterior of the rolling-element bearing in the interior of the rolling-element bearing 100.

Here in one exemplary embodiment the recess can be configured such that it surrounds the seal ring 140 in a contact-free manner up to the contact of the seal lip 144 with the surface of the recess, or conversely the seal ring 140 is configured such that up to the contact of the seal lip 144 with the surface of the recess, it does not contact the recess.

In the specific example of FIG. 1, a plurality of the described, optional embodiments are combined with one another. In this example the seal ring 140 has an essentially rectangular basic shape. However, from the basic shape is by a bulge on the lateral surface with which the seal ring 140 is disposed on the inner ring 110, a seal lip on a lateral surface of the seal ring 140, which lateral surface of the seal ring 140 is orthogonal to the surface of the inner ring 110, and an indentation leading obliquely in the seal ring 140, in which a garter spring 142 is disposed. Here the indentation is formed between the seal lip 144 and the rest of the seal ring and leads from the side of the seal ring 140 including the seal lip 144 towards that lateral surface of the seal ring 140 with which the seal ring 140 is disposed on the inner ring 110.

As already mentioned, the seal effect of the labyrinth ring is better the smaller the distance is of the recess to the seal ring 140. For example, the recess and the seal ring 140 can be configured such that a smallest distance of a surface of the recess from the seal ring in the axial direction of the rolling-element bearing 100 is less than 5 mm (or 3 mm, 1 mm, or 0.5 mm), in particular between 0.5 mm and 3 mm, and in the radial direction is smaller than 1 cm (or smaller than 7 mm, 5 mm, or 3 mm). Since the deforming of the rolling-element bearing 100 in operation is normally smaller in the axial direction (in the direction parallel to the rotational axis of the rolling-element bearing) than in the radial direction (orthogonal to the rotational axis of the rolling-element bearing), a rolling-element bearing can have a smaller smallest distance in the axial direction of the surface of the recess from the seal ring than in the radial direction.

Normally a rolling-element bearing has two sides on which the interior of the rolling-element bearing 100, in which the rolling elements 130 are disposed, should be sealed with respect to the exterior of the rolling-element bearing 100. Here different seal concepts can be used on the two sides. Usually, however, essentially the same sealing concept is used on both sides. In one such example (as is also shown in FIG. 1), the rolling-element bearing 100 includes a second seal ring 180. The second seal ring 180 is disposed on a surface of the inner ring 110 or of the outer ring 120, and the outer ring 120 or the inner ring 110 correspondingly includes a further recess. The further recess is configured and disposed to surround a predominant part of the exposed surface of the second seal ring 180 in a contact-free manner so that a labyrinth seal is formed, by the second seal ring 180 and the further recess, between an interior of the rolling-element bearing 100 for receiving the rolling elements 130 and an exterior of the rolling-element bearing 100, and the interior of the rolling-element bearing 100 for receiving the rolling elements 130 is sealed on both (two) sides of the rolling-element bearing 100 by the formed labyrinth seals. For the second seal ring 180 and the further recess, one or more of the above-described possible designs of the first seal ring 140 and its recess can optionally be realized.

The described concept with its optional designs is an interesting sealing concept for large bearings. A rolling-element bearing from a diameter of, for example, 50 cm can be referred to as a large bearing. However, some exemplary embodiments relate to the implementing of the described concept in rolling-element bearings having a diameter of more than 1 m, more than 1.8 m, more than 2.5 m, or even more than 4 m. Here the diameter of a rolling-element bearing can be defined, for example, by an inner diameter of the inner ring, an average diameter of the interior of the rolling-element bearing, or an outer diameter of the outer ring, or in a similar manner.

The rolling-element bearing can be, for example, a cylindrical roller bearing, or a tapered roller bearing, and in particular a double row or a four-row tapered roller bearing.

However, an implementation of the described sealing concept is not only interesting in large bearings. FIG. 1 shows an example of a rolling-element bearing 100 including an inner ring 110, an outer ring 120, a plurality of rolling elements 130 lying between the inner ring 110 and the outer ring 120, and at least one seal ring 140. The seal ring 140 is disposed on a surface of the inner ring 110 or of the outer ring 120 and correspondingly the outer ring 120 or the inner ring 110 includes a recess. The recess is configured and disposed to surround a predominant part of the exposed surface of the seal ring 140 in a contact-free manner so that a labyrinth seal is formed, by the seal ring 140 and the recess, between an interior of the rolling-element bearing 100 for receiving the rolling elements 130 and an outer ring of the rolling-element bearing 100. Furthermore the seal ring 140 is comprised at least partially of a rubber elastomer or a thermoplastic polymer, in particular polyurethane.

By using a seal ring that is comprised at least partially of a rubber elastomer or a thermoplastic polymer, a labyrinth seal can be formed that is in principle a non-contact seal, with which, however, significant damage cannot even occur if in operation the seal ring contacts the surface of the recess from time to time. In contrast to the use of steel rings as the seal ring for labyrinth seals, the minimum space between a surface of the recess and the seal ring can be reduced by the described concept, so that the seal effect of the labyrinth seal is increased, and/or the use of a labyrinth seal in rolling-element bearings having large diameters (greater than 50 cm) is made possible, since steel rings in such large diameters are difficult to integrate in the rolling-element bearing, and the movement tolerances in large bearings are higher. By using a labyrinth seal as a non-contact seal the maintenance cost can generally be reduced. In addition, with the use of a seal ring according to the described concept a contact of the seal ring with the surface of the recess can cause far less damage than a contact of a seal ring made from steel, so that at this location the maintenance cost can also be reduced.

Furthermore, one or more of the above-described optional implementation variants can be realized for the rolling-element bearing 200.

Some exemplary embodiments relate to a non-contact seal (labyrinth) for a DRTRB (Nautilus, double row tapered roller bearing) with integrated dust lips (seal lips). According to the described concept a (useful) labyrinth seal can be simply realized for large bearings, in particular double row tapered roller bearings. This sealing concept is realizable in terms of cost and feasibility. In comparison to radial shaft seals used to date, a non-contact system can be provided by the described labyrinth seal.

A simple, cost-effective labyrinth seal can be manufactured using the described concept. The bearing, seal carrier (recess-forming component) and cover can be serial parts. The labyrinth ring (seal ring), e.g., made of polyurethane, can be installed with a spring preload (e.g. with a garter spring). For example, the seal can be realized by a single change to the series status (of the inner ring) by a radial groove on the inner ring. Thus it can be that no fundamental design changes to the series part are necessary. Thus this would have a small influence on the process chain. The seal can be replaceable (due to the removable cover) without the bearing having to be removed. A seal lip can be integrated on the labyrinth ring (seal ring). This is a safeguarding against environmental influences (dust, water). Alternatively this can be achieved using an additional V-ring. With this implementation (seal lip on the seal ring) this function is integrated on the labyrinth ring.

The features disclosed in the foregoing description, in the claims that follow, and in the drawings can be relevant individually, as well as in any combination, to the realization of the invention in its various embodiments.

Although some aspects of the present invention have been described in the context of a device, it is to be understood that these aspects also represent a description of a corresponding method, so that a block or a component of a device is also understood as a corresponding method step or as a characteristic of a method step, for example a method for manufacturing or operating a filter cartridge. In an analogous manner, aspects which have been described in the context of or as a method step also represent a description of a corresponding block or detail or feature of a corresponding device.

The above-described exemplary embodiments represent only an illustration of the principles of the present invention. It is understood that modifications and variations of the arrangements and details described herein will be clear to other persons of skill in the art. It is therefore intended that the invention be limited only by the scope of the following patent claims, and not by the specific details which have been presented with reference to the description and the explanation of the exemplary embodiments.

### REFERENCE NUMBER LIST

100/200 Rolling-element bearing
110 Inner ring
112 Groove
120 Outer ring
130 Rolling elements
140 Seal ring
142 Garter spring
144 Seal lip
150 Recess-forming component
160 Cover
170 Releasable connecting means
180 Second seal ring

1. A rolling-element bearing having a diameter greater than 50 cm and comprising:
an inner ring;
an outer ring;
a plurality of rolling elements lying between the inner ring and the outer ring; and
a seal ring, wherein the seal ring is disposed on a surface of the inner ring or on a surface of the outer ring and correspondingly the outer ring or the inner ring includes a recess, wherein the recess is configured and disposed to surround a predominant part of an exposed surface of the seal ring in a contact-free manner so that a labyrinth seal is formed, by the seal ring and the recess, between an interior of the rolling-element bearing and an exterior of the rolling-element bearing.

2. The rolling-element bearing according to claim 1, wherein the seal ring is comprised at least partially of a rubber elastomer or a thermoplastic polymer.

3. The rolling-element bearing according to claim 1, wherein the recess surrounds the seal ring in a U-shaped manner.

4. The rolling-element bearing according to claim 1, wherein the seal ring is disposed on a surface of the inner ring and the outer ring includes the recess, wherein the outer ring comprises a recess-forming component and a cover, which together form the recess, and wherein the cover is releasably connected to the recess-forming component.

5. The rolling-element bearing according to claim 4, wherein the recess-forming component lies opposite the seal ring on two sides in an L-shape, and the cover lies opposite the seal ring on a third side, so that the recess-forming component and the cover surround the seal ring in a U-shaped manner.

6. The rolling-element bearing according to claim 1, wherein the seal ring is disposed on a surface of the inner ring and the outer ring includes the recess, wherein the inner ring includes a groove and the seal ring includes a bulge protruding into the groove so that the seal ring is held in its position on the surface of the inner ring.

7. The rolling-element bearing according to claim 1, wherein the seal ring is disposed on a surface of the inner ring and the outer ring includes the recess, wherein the seal ring comprises a seal body and a garter spring, wherein the seal body and the garter spring are configured and disposed such that the seal body is pressed by the garter spring against the inner ring.

8. The rolling-element bearing according to claim 1, wherein the seal ring includes a seal lip that extends from the a body portion of the seal ring to a surface of the recess and is in contact with the surface of the recess.

9. The rolling-element bearing according to claim 8, wherein the seal lip forms an acute angle with the surface of the recess, so that a contact surface of the seal lip with the surface of the recess is spaced further from the interior of the rolling-element bearing than a terminal region of the seal lip on the body portion of the seal ring.

10. The rolling-element bearing according to claim 8, wherein the recess surrounds the seal ring in a contact-free manner up to the contact of the seal lip with the surface of the recess.

11. The rolling-element bearing according to claim 1, wherein a smallest distance of a surface of the recess from the seal ring in an axial direction of the rolling-element bearing is between 3 mm and 5 mm.

12. The rolling-element bearing according to claim 1, wherein the recess is configured such that the exposed surface of the seal ring is completely surrounded by the recess up to a gap towards the interior of the rolling-element bearing and a gap towards the exterior of the rolling-element bearing, wherein a maximum distance of a point of the exposed surface of the seal ring to a closest point on a surface of the recess is less than 2 cm.

13. The rolling-element bearing according to claim 1, wherein the rolling-element bearing is a cylindrical roller bearing or a tapered roller bearing.

14. The rolling-element bearing according to claim 1, wherein the rolling-element bearing includes a second seal ring, wherein the second seal ring is disposed on a surface of the inner ring or of the outer ring, and correspondingly the outer ring or the inner ring includes a further recess, wherein the further recess is configured and disposed to surround a predominant part of an exposed surface of the second seal ring in a contact-free manner, so that a second labyrinth seal is formed, by the second seal ring and the further recess, between an interior of the rolling-element bearing and an exterior of the rolling-element bearing, and the interior of the rolling-element bearing is sealed on two sides of the rolling-element bearing by the formed labyrinth seals.

15. A rolling-element bearing comprising:
an inner ring;
an outer ring;
a plurality of rolling elements lying between the inner ring and the outer ring; and
at least one seal ring, wherein the seal ring is disposed on a surface of the inner ring or on a surface of the outer ring and correspondingly the outer ring or the inner ring includes a recess, wherein the recess is configured and disposed to surround a predominant part of an exposed surface of the seal ring in a contact-free manner so that a labyrinth seal is formed, by the seal ring and the recess, between an interior of the rolling-element bearing and an exterior of the rolling-element bearing,
wherein the seal ring is comprised at least partially of a rubber elastomer or a thermoplastic elastomer.

16. The rolling-element bearing according to claim 1, wherein the seal ring is comprised at least partially of polyurethane.

17. The rolling-element bearing according to claim 1,
wherein the seal ring is comprised at least partially of a rubber elastomer or a thermoplastic polymer,
wherein the recess surrounds the seal ring in a U-shaped manner,
wherein the seal ring is disposed on a surface of the inner ring and the outer ring includes the recess, wherein the outer ring comprises a recess-forming component and a cover, which together form the recess, and wherein the cover is releasably connected to the recess-forming component,
wherein the recess-forming component lies opposite the seal ring on two sides in an L-shape, and the cover lies opposite the seal ring on a third side,
wherein the inner ring includes a groove and the seal ring includes a bulge protruding into the groove so that the seal ring is held on the surface of the inner ring,
wherein the seal ring comprises a seal body and a garter spring configured and disposed such that the seal body is pressed by the garter spring against the inner ring,
wherein the seal ring includes a seal lip that extends from the seal body to a surface of the recess and is in contact with the surface of the recess,
wherein the seal lip forms an acute angle with the surface of the recess, so that a contact surface of the seal lip with the surface of the recess is spaced further from the interior of the rolling-element bearing than a terminal region of the seal lip on the seal body,
wherein the recess surrounds the seal ring in a contact-free manner up to the contact of the seal lip with the surface of the recess, and
wherein a smallest distance of a surface of the recess from the seal ring in an axial direction of the rolling-element bearing is between 3 mm and 5 mm.

18. A rolling-element bearing having a diameter greater than 50 cm and comprising:
an inner ring;
an outer ring;
a plurality of rolling elements between the inner ring and the outer ring; and
a seal ring,
wherein the seal ring is disposed on a surface of the inner ring or on a surface of the outer ring and wherein the outer ring or the inner ring includes a recess having at least one interior surface, and wherein the seal ring extends into the recess, and
wherein the seal ring does not contact the at least one interior wall of the recess or wherein the seal ring comprises a seal body and a seal lip and the seal body does not contact the at least one interior wall of the recess.

19. The rolling-element bearing according to claim 18, wherein the seal ring is comprised at least partially of a rubber elastomer or a thermoplastic polymer.

20. The rolling-element bearing according to claim 1, wherein the recess is formed by first and second walls of the outer ring and by a cover releasably attached to the outer ring.
